(19) United States
(12) Patent Application Publication
(10) Pub. No.: US 2009/0024740 A1
(43) Pub. Date: Jan. 22, 2009

(54) Neighborhood block communication method and system

(75) Inventor: Raj Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/899,430

(22) Filed: Sep. 5, 2007

Related U.S. Application Data
(60) Provisional application No. 60/961,388, filed on Jul. 20, 2007.

(51) Int. Cl. G06F 15/173; G06F 17/30

(52) U.S. Cl. 709/225; 707/3; 707/E17.014

(57) ABSTRACT

A method and system of neighborhood block communication is disclosed. In one embodiment, a method of communication in a neighborhood block includes obtaining member data associated with a first member of the community network, determining a first location associated with the first member based on the member data, storing the member data in a member repository, determining a first number of points associated with the first member, and obtaining a first region of communication for the first member based on the first location and the first number of points. The method may further include displaying the first region of communication on a geo-spatial map. The method may also include bounding the first region of communication based on a connectedness of the first member in the first region of communication.

### PRIORITY CLAIM

This disclosure claims priority to U.S. provisional patent application 60/961,388, titled “Method and system of determining regions of influence in a community network” filed on Jul. 20, 2007.

### FIELD OF TECHNOLOGY

This disclosure relates generally to the technical fields of communications and, in one example embodiment, to a method and system of neighborhood block communication.

### BACKGROUND

A community network may correspond to a social structure made of nodes which may include individuals and/or organizations, and links between the nodes. The links may correspond to varying degrees of social familiarity, from those of casual acquaintances to close familial bonds. Community networks may be tracked and maintained on web-based applications, enabling friends, neighbors, business partners, and/or other individuals to connect with one another using a variety of tools. Additionally, formation of the community networks on the web-based applications may allow parties to connect with one another regardless of geographic proximity.

In online community networks, users may create profiles that include information such as a name, address, contact information, picture, and/or other personal information. For example, a friend-based community network may allow the users to upload photos to their profiles, while a business community network may allow users to include work experience, education, and/or references on their profiles. The online community networks may further allow the profiles to be edited by other users. For example, the users may be allowed to leave comments, testimonials, and/or recommendations on other users' profiles, and/or associate the other users with uploaded pictures, videos, and/or other media.

Connections, or links, may be made between users in an online community network. For example, two users on the friend-based community network may become “friends” if both the users approve the connection. Similarly, a business connection may be made on a business community network if two users have worked together and/or are interested in collaborating on future work. Connections, or links, between the users may form the basis of the online community networks and community network theory in general.

Community networks on a hyper local level (e.g., a neighborhood or street level) may include individuals with significant desire to reach out to other people in a particular area, neighborhood, and/or demographic regardless of whether those individuals have signed up for the community network. For example, a block leader (e.g., a Neighborhood Watch leader) may wish to communicate safety and/or crime prevention information with all the people on their street. To effectively talk with everybody on their street, the block leader may need to walk door to door and speak with neighbors. This can be a slow and inefficient process.

### SUMMARY

A method and system of neighborhood block communication is disclosed. In one aspect, a method of communication in a neighborhood block includes obtaining member data associated with a first member of the community network, determining a first location associated with the first member based on the member data, storing the member data in a member repository, determining a first number of points (e.g., based on an activity level of the first member) associated with the first member, and obtaining a first region of communication (e.g., a sphere) for the first member based on the first location and the first number of points. The method may further include displaying the first region of communication on a geo-spatial map. The method may also include bounding the first region of communication based on a connectedness of the first member in the first region of communication.

The method may further include obtaining a second location associated with a second member of the community network, determining a second number of points associated with the second member, obtaining a second region of communication for the second member based on the second location and the second number of points, and bounding the first region of communication by the second region of communication based on an inequality between the first number of points and the second number of points.

In another aspect, a community network includes a member repository including a number of members, a geo-spatial repository including a number of locations on a geo-spatial map, a member management module configured to obtain member data associated with each of the members, and a block communication module configured to determine a first location (e.g., including a latitude and a longitude) associated with a first member based on the member data, store the member data in the member repository, determine a first number of points (e.g., based on an activity level of the first member) associated with the first member, and obtain a first region of communication (e.g., may include a sphere) for the first member based on the first location and the first number of points.

In addition, the member management module may be configured to determine an activity level of each of the members in the member repository. The block communication module may also be configured to display the first region of communication on the geo-spatial map. The block communication module may also be configured to bound the first region of communication based on a connectedness of the first member in the first region of communication.

In addition, the block communication module may be configured to obtain a second location (e.g., including a latitude and a longitude) associated with a second member, determine a second number of points associated with the second member, obtain a second region of communication (e.g., may include a sphere) for the second member based on the second location and the second number of points, and bound the first region of communication by the second region of communication based on an inequality between the first number of points and the second number of points.

In yet another aspect, a method of configuring a community network for a first user includes obtaining a location request from the first user, displaying a first location corresponding to the location request to the first user, determining a first region of communication (e.g., may include a sphere) based on a first number of points (e.g., based on an activity level of the first user) associated with the first user and the first location, and displaying the first region of communication on a geo-spatial map to the first user.

The method may further include receiving a request to increase the first region of communication from the first user, determining an eligibility of the first user for the increase, and increasing the first region of communication based on the eligibility and the first number of points. The method may also include bounding the first region of communication based on a connectedness of the first user in the first region of communication.

In addition, the method may include obtaining a second user of the community network in a vicinity of the first region of communication, obtaining a second region of communication based on a second number of points associated with the second user and a second location associated with the second user, and bounding the first region of communication based on the second number of points and the second region of communication.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a community network communicating with members of a community, according to one embodiment.

FIG. 2A is a user interface view of a webpage associated with a user, according to one embodiment.

FIG. 2B is a user interface view displaying an increased region of communication associated with the user, according to one embodiment.

FIG. 2C is a user interface view displaying a webpage associated with a member in a vicinity of the region of communication, according to one embodiment.

FIG. 3 is a block diagram representation displaying information associated with a member, according to one embodiment.

FIG. 4 is a flow chart to obtain a region of communication for the member, according to one embodiment.

FIG. 5 is a flow chart to increase a region of communication of a user based on an eligibility and a number of points, according to one embodiment.

FIG. 6 is a diagrammatic system view of a data processing system in which any of the embodiments disclosed herein may be performed, according to one embodiment.

FIG. 7A is a process flow illustrating a method of communication in a neighborhood block, according to one embodiment.

FIG. 7B is a continuation of the process flow of FIG. 7A, showing additional processes, according to one embodiment.

FIG. 8A is a process flow of bounding a first region of communication based on a second number of points and a second region of communication, according to one embodiment.

FIG. 8B is a continuation of the process flow of FIG. 8A, showing additional processes, according to one embodiment.

Other features of the present embodiments will be apparent from the accompanying drawings and from the detailed description that follows.

### DETAILED DESCRIPTION

A method and system of neighborhood block communication is disclosed. In the following description, for the purposes of explanation, numerous specific details are set forth in order to provide a thorough understanding of the various embodiments. It will be evident, however to one skilled in the art that the various embodiments may be practiced without these specific details.

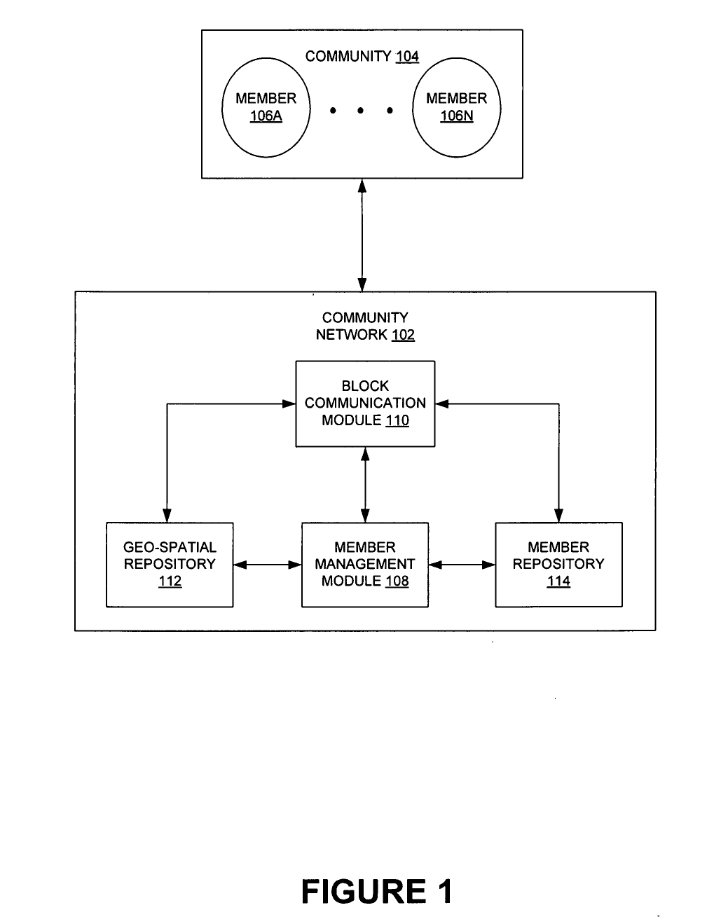

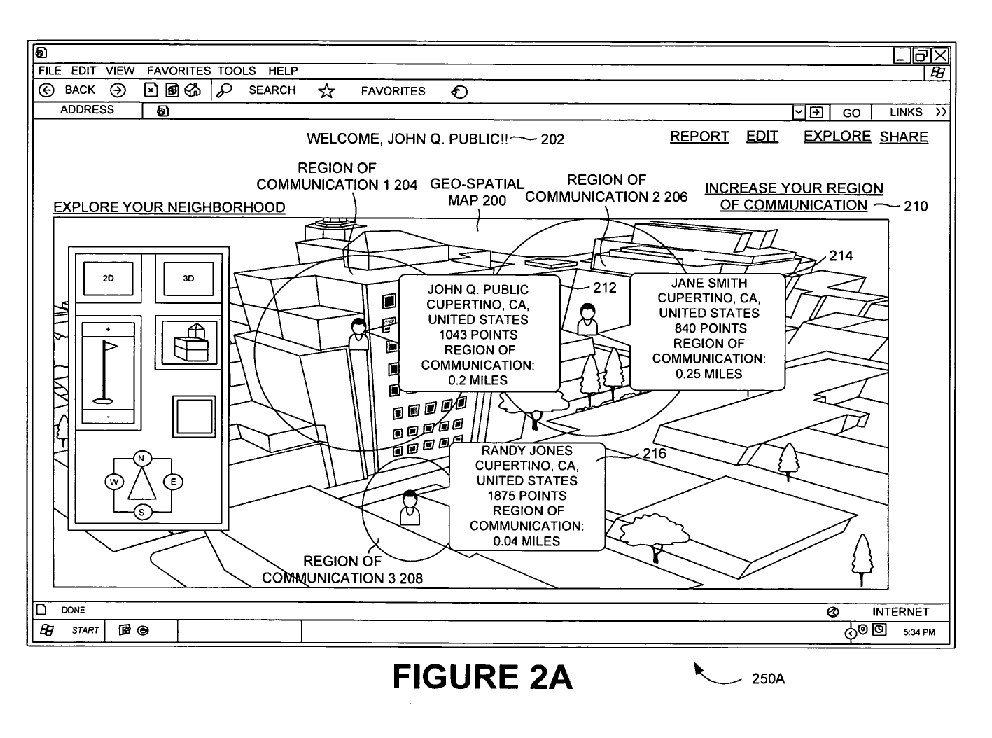

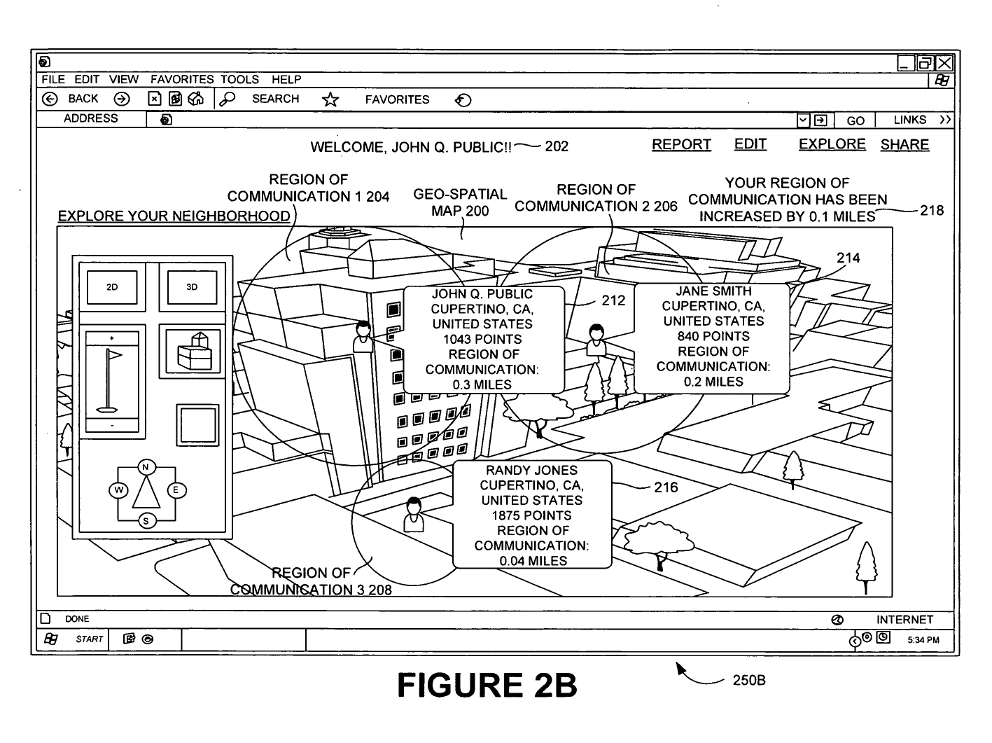

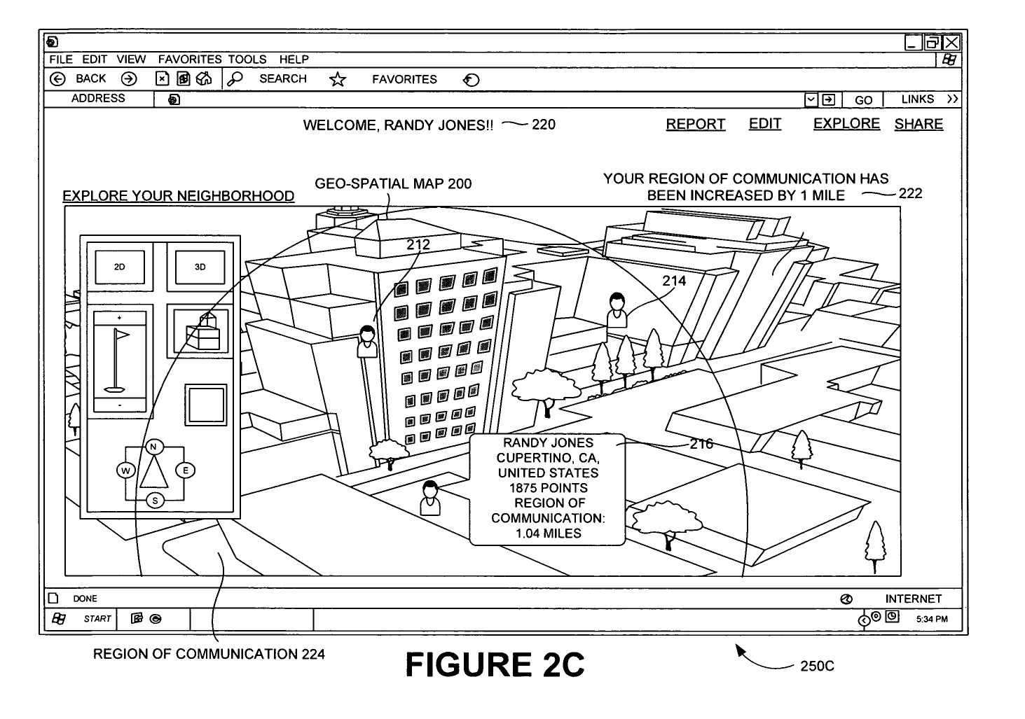

In one embodiment, a method of communication in a neighborhood block includes obtaining member data (e.g., using the member management module 108 of FIG. 1) associated with a first member 106 of the community network 102, determining a first location (e.g., using the block communication module 110 of FIG. 1) associated with the first member 106 based on the member data, storing the member data in a member repository (e.g., the member repository 114 of FIG. 1), determining a first number of points (e.g., based on an activity level of the first member 106) associated with the first member 106, and obtaining (e.g., using the block communication module 110 of FIG. 1) a first region of communication (e.g., the region of communication 1 204 of FIG. 2A, a sphere, etc.) for the first member 106 based on the first location and the first number of points.

In another embodiment, a community network 102 includes a member repository 114 containing (e.g., storing data associated with) a number of members (e.g., the members 106A-N of FIG. 1), a geo-spatial repository (e.g., the geo-spatial repository 112 of FIG. 1) containing a number of locations on a geo-spatial map (e.g., the geo-spatial map 200 of FIGS. 2A, 2B and 2C), a member management module (e.g., the member management module 108 of FIG. 1) configured to obtain member data associated with each of the members 106A-N, and a block communication module (e.g., the block communication module 110 of FIG. 1) configured to determine a first of the number of locations (e.g., may include a latitude and a longitude) associated with a first member 106 based on the member data, store the member data in the member repository 114, determine a first number of points (e.g., based on the activity level of the first member 106) associated with the first member 106, and obtain a first region of communication 1 204 (e.g., may include a sphere) for the first member 106 based on the first location and the first number of points.

In yet another embodiment, a method of configuring a community network 102 for a first user (e.g., the first member 106) includes obtaining a location request from the first user, displaying (e.g., through the geo-spatial map 200 of FIG. 2A) a first location corresponding to the location request to the first user, determining (e.g., using the block communication module 110 of FIG. 1) a first region of communication 1 204 (e.g., may include a sphere) based on a first number of points (e.g., determined based on an activity level of the first user) associated with the first user and the first location, and displaying the first region of communication 1 204 on a geo-spatial map 200 to the first user.

FIG. 1 is a system view of a community network 102 communicating with members 106A-N of a community 104, according to one embodiment. Particularly, FIG. 1 illustrates the community network 102, the community 104, the members 106A-N, a member management module 108, a block communication module 110, a geo-spatial repository 112 and a member repository 114, according to one embodiment.

The community network 102 may be a network formed by association of the members 106A-N having user profiles in the community 104. For example, the community network 102 may enable the members 106A-N of the community 104 to create profiles containing the information such as a name, an address, a contact information, a picture and/or other personal information. The community 104 may refer to a group of members 106A-N residing in a particular area, neighborhood and/or demographic.

The members 106A-N may include individuals with significant influence in the community 104. The members 106A-N may include individuals who wish to communicate with people in their neighborhoods. For example, the individuals having influence may include block watch leaders, realtors, city personal, neighborhood watch leaders, leaders, social workers, contributors, athletes, people who participate in physical activities, coaches, officials, volunteers, administrators, groups and organizations, levels of government, public sector agencies (e.g., schools, universities, health groups, etc.) founders and program/service providers and/or other well-connected people associated with the community network 102. The members 106A-N may also reside in multiple regions (e.g., multiple cities, states, countries, etc.). The members 106A-N may be connected to each other through the community network 102.

The member management module 108 may obtain member data associated with the members 106A-N of the community 104. For example, the member data may include a name, age, profession, and/or address data associated with the members 106A-N. The member data may be displayed in profiles of the members 106A-N. In addition, the profiles of the members 106A-N in a region of communication (e.g., the region of communication 1 204 of FIGS. 2A and 2B) may be editable by an individual with significant influence based on his/her connectedness in the region of communication 1 204. For example, connectedness may refer to a number of links or connections or friends associated with the member 106 in a particular region of communication 1 204. In addition, the individual (e.g., the member 106) with significant influence may be allowed to communicate with other members 106A-N in the region of communication 1 204 through physical mails, IM, emails, and/or voice calls, etc.

The member management module 108 may determine an activity level of each of the members 106A-N in the member repository 114. For example, the activity level may include intensity and/or extent of participation of the member 106 in the community network 102. The activity level may be a way to express daily activities of the member in terms of number of points allocated (e.g., on a periodic basis to each member 106 of the community network 102). In addition, the activity level may also be estimated based on a list of the activities that the members 106A-N perform from day to day. For example, each activity is connected to a number of points and may include building up the community network 102, creating and/or deleting profiles, leaving comments, social services and/or other leisure-time activities, etc.

The block communication module 110 may obtain a region of communication (e.g., the regions of communication 1 204, 2 206 and 3 208 of FIGS. 2A and 2B) for each of the members 106A-N based on a location and/or a number of points associated with each of the members 106A-N. For example, the block communication module 110 may determine the location (e.g., based on the member data) and/or the number of points associated with each of the members 106 (e.g., based on the activity level of each of the members 106A-N). For example, the region of communication 1 204 may be a sphere having a certain radius (e.g., may be determined based on the number of points). In one example embodiment, selection tools may be used to draw the region of communication 1 204 on a geo-spatial map (e.g., the geo-spatial map 200 of FIG. 2A).

The block communication module 110 may bound the region of communication 1 204 associated with each of the members 106A-N based on a connectedness of each member 106 in the region of communication 1 204. For example, the number of points associated with a first member 106 and a second member 106 may be 100 and 200 respectively. The block communication module 110 may obtain a first region of communication 1 204 and a second region of communication 2 206 associated with the first member 106 and the second member 106 respectively (e.g., based on the number of points of the first and second member 106).

In addition, the block communication module 110 may bound the first region of communication 1 204 by the second region of communication 2 206 as the number of points associated with the second member 106 is higher than that of the first member 106. The block communication module 110 may increase a radius of the second region of communication 2 206 based on the number of points. For example, the second member 106 may have greater influence than the first member 106 such that the second member 106 may set trends, communicate with other members 106A-N and/or create groups and events over a larger region as compared to the first member 106.

The geo-spatial repository 112 may be a database containing location information associated with the members 106A-N of the community 104 on the geo-spatial map 200. The member repository 114 may be a database containing member data associated with the members 106A-N. In one example embodiment, locations associated with the members 106A-N may be obtained based on the member data stored in the member repository 114.

In the example embodiment illustrated in FIG. 1, the members 106A-N of the community 104 communicate with each other through the community network 102. For example, a member 106 having a region of communication 1 204 communicates with the other members 106A-N within the region of communication 1 204 through the community network 102.

The member 106 may create groups, events and/or send messages to the other members 106A-N within the region of communication 1 204 based on connectedness of the member 106 having the region of communication 1 204. For example, the connectedness may refer to connections of the members 106A-N with each other though social links. The member 106 having the region of communication 1 204 may communicate with other members 106A-N within the region of communication 1 204 using a variety of methods, such as physical mail, email, text messaging, instant messaging, and/or telephone, etc.

In the example embodiment illustrated in FIG. 1, the community network 102 includes the member management module 108, the block communication module 110, the geo-spatial repository 112, and the member repository 114, interacting with each other.

In one embodiment, member data associated with a first member 106 of the community network 102 may be obtained (e.g., using the member management module 108 of FIG. 1) and a first location (e.g., includes a latitude and a longitude) associated with the first member 106 may be determined (e.g., using the geo-spatial repository 112 of FIG. 1) based on the member data. Further, the member data may be stored in the member repository 114. A first number of points associated with the first member 106 may be determined (e.g., based on an activity level of the first member 106) and the first region of communication 1 204 (e.g., may include a sphere) for the first member 106 may be obtained (e.g., using the block communication module 110 of FIG. 1) based on the first location and the first number of points. As a result, the first region of communication 1 204 (e.g., associated with first member 106) may be displayed (e.g., concurrently with region(s) of communication 2 206 and 3 208 associated with other members 106A-N) on a geo-spatial map (e.g., the geo-spatial map 200 of FIGS. 2A and 2B).

In another embodiment, the first region of communication 1 204 may be bounded (e.g., using the block communication module 110 of FIG. 1) based on a connectedness of the first member 106 in the first region of communication 1 204. A second location associated with a second member 106 of the community network 102 may be obtained (e.g., using the member repository 114 of FIG. 1) and a second number of points associated with the second member 106 may be determined (e.g., using the block communication module 110 of FIG. 1).

Further, a second region of communication (e.g., the region of communication 2 206 of FIG. 2A) for the second member 106 may be obtained (e.g., using the block communication module 110 of FIG. 1) based on the second location and the second number of points. For example, the first region of communication 1 204 may be bounded (e.g., using the block communication module 110 of FIG. 1) by the second region of communication 2 206 based on an inequality between the first number of points and the second number of points.

In one embodiment, the member repository 114 may include a number of members (e.g., the members 106A-N of FIG. 1). The geo-spatial repository 112 may include a number of locations on the geo-spatial map 200. The member management module 108 may be configured to obtain the member data associated with each of the members 106A-N. The member management module 108 may be further configured to determine an activity level of each of the members 106A-N in the member repository 114. The block communication module 110 may be configured to determine the first location (e.g., including a latitude and longitude) associated with the first member 106 based on the member data, store the member data in the member repository 114, determine the first number of points (e.g., based on an activity level of the first of the member 106) associated with the first member 106, and obtain the first region of communication 1 204 (e.g., may include a sphere) for the first member 106 based on the first location and the first number of points (e.g., as illustrated in the profile block(s) 212, 214 and 216 of FIGS. 2A, 2B and 2C).

The block communication module 110 may also be configured to display the first region of communication 1 204 on the geo-spatial map 200. In addition, the block communication module 110 may be configured to bound the first region of communication 1 204 based on the connectedness of the first member 106 in the first region of communication 1 204, obtain the second location associated with the second member 106, determine the second number of points associated with the second member 106, obtain the second region of communication 2 206 for the second member 106 based on the second location and the second number of points, and bound the first region of communication 1 204 by the second region of communication 2 206 based on the inequality between the first number of points and the second number of points.

FIG. 2A is a user interface view 250A of a webpage associated with a user, according to one embodiment. Particularly, FIG. 2A illustrates a geo-spatial map 200, a welcome message 202, a region of communication 1 204, a region of communication 2 206, a region of communication 3 208, an increase your region of communication option 210 and profile block(s) 212, 214, and 216, according to one embodiment.

The geo-spatial map 200 may graphically display member data (e.g., name and/or address), number of points and/or regions of communication 1 204, 2 206 and 3 208 associated with the members 106A-N. The welcome message 202 may display a name of a user (e.g., an owner of a webpage). The regions of communication 1 204, 2 206 and 3 208 may be spheres having certain radii, determined based on the number of points and/or the locations associated with the members 106A-N. In one example embodiment, the region of communication 1 204 may be a sphere drawn for the user (e.g., John Q. Public). The region of communication 2 206 and the region of communication 3 208 may be regions of communication drawn corresponding to other members 106A-N (e.g., Jane Smith and Randy Jones) in the vicinity of the user's region of communication 1 204.

The increase your region of communication option 210 may enable the user (e.g., John Q. Public) to request an increase in the region of communication 1 204. The profile blocks 212, 214 and 216 may display profile information associated with the members 106A-N. For example, the profile information may include name, address, number of points and radius of regions of communication 1 204, 2 206 and 3 208 associated with the members 106A-N. As illustrated in FIG. 2A, the profile block 212 may contain the profile information associated with the user and the profile blocks 214 and 216 may contain the profile information associated with the other members 106A-N surrounding the region of communication 1 204.

In the example embodiment illustrated in FIG. 2A, the user interface view 250A displays the profile information and the regions of communication 1 204, 2 206 and 3 208 associated with the user and other members 106A-N in the vicinity of the first region of communication 1 204. The user interface view 250A also displays the welcome message 202 associated with the user. The welcome message 202 displays “Welcome, John Q. Public” representing a homepage (e.g., a landing page view) associated with the user “John Q. Public”. The profile block 212 displays name “John Q. Public”, address “Cupertino, Calif., United States”, number of points “1043”, and radius of the region of communication 1 204 “0.2 miles” associated with John Q. Public. The profile block 214 displays a member “Jane Smith”, address “Cupertino, Calif., United States”, number of points “840”, and radius of the region of communication 2 206 “0.25 miles” associated with Jane Smith in the vicinity of John Q. Public's region of communication 1 204. The profile block 216 displays a member “Randy Jones”, address “Cupertino, Calif., United States”, number of points “1875”, and radius of the region of communication 3 208 “0.04 miles” associated with Randy Jones in the vicinity of John Q. Public's region of communication 1 204.

As illustrated in FIG. 2A, the radius of the sphere drawn corresponding to the region of communication 1 204 associated with John Q. Public is 0.2 miles. The radius of the region of communication 2 206 associated with Jane Smith is 0.25 miles. As the number of points (e.g., 1043) associated with John Q. Public is more than the number of points (e.g., 840) associated with Jane Smith and John Q. Public's region of communication 1 204 is less than that of Jane Smith's region of communication 2 206, John Q. Public may request to increase the region of communication 1 204 through the increase your region of communication option 210. For example, an eligibility of John Q. Public to increase of the region of communication 1 204 may be determined (e.g., using the block communication module 110 of FIG. 1). As a result, the region of communication 1 204 may be increased based on the eligibility and the number of points associated with John Q. Public.

In one embodiment, a location request may be obtained from the first user (e.g., John Q. Public). A first location corresponding to the location request may be displayed (e.g., on the geo-spatial map 200 of FIG. 2A) to the first user. A first region of communication 1 204 (e.g., a sphere) may be determined (e.g., using the block communication module 110 of FIG. 1) based on a first number of points (e.g., the first number of points may be determined based on an activity level of the first user) and the first location associated with the first user. As a result, the first region of communication 1 204 may be displayed on a geo-spatial map 200 to the first user. In addition, a request to increase the first region of communication 1 204 may be received (e.g., using the increase your region of communication option 210) from the first user.

In another embodiment, a second user (e.g., Jane Smith) of the community network in a vicinity of the first region of communication 1 204 may be obtained (e.g., using the member data). A second region of communication (e.g., the region of communication 2 206 of FIG. 2A) may be obtained (e.g., using the block communication module 110 of FIG. 1) based on a second number of points (e.g., determined based on an activity level of the second user) associated with the second user and a second location of the second user.

FIG. 2B is a user interface view 250B displaying an increased region of communication 1 204 associated with the user, according to one embodiment. Particularly, FIG. 2B illustrates the geo-spatial map 200, the welcome message 202, the region of communication 1 204, the region of communication 2 206, the region of communication 3 208, the profile blocks 212, 214 and 216 and a message block 218, according to one embodiment.

The message block 218 may display a message related to the user's request to increase the region of communication 1 204 (e.g., John Q. Public's request). In the example embodiment illustrated in FIG. 2B, the user interface view 250B displays profile information, the welcome message 202, the regions of communication 1 204, 2 206 and 3 208 associated with the user (e.g., John Q. Public) and the members 106A-N (e.g., Jane Smith and Randy Jones) in the vicinity of the first region of communication 1 204. The user interface view 250B also displays the welcome message 202 and the message block 218. The welcome message displays “Welcome, John Q. Public” representing a home page (e.g., a landing page view) associated with the user “John Q. Public”.

The message block 218 displays “Your region of communication has been increased by 0.1 miles” corresponding to John Q. Public's request to increase the region of communication 1 204. In one example embodiment, the radius of the region of communication 1 204 is increased from 0.2 miles to 0.3 miles based on John Q. Public's request and the number of points associated with John Q. Public (e.g., higher than the number of points associated with Jane Smith).

For example, the region of communication 2 206 may be bounded by the region of communication 1 204 based on the inequality between the number of points associated with John Q. Public and the surrounding member 106 (e.g., Jane Smith). For example, the more the number of points the larger the region of communication 2 206 will be. As a result, the region of communication 1 204 is increased by 0.1 miles based on the inequality between the number of points associated with John Q. Public and Jane Smith.

In one embodiment, an eligibility of the first user (e.g., John Q. Public) for the increase of the first region of communication 1 204 may be determined (e.g., based on John Q. Public's request). The first region of communication 1 204 may be increased based on the eligibility and the first number of points. The first region of communication 1 204 may be bounded (e.g., using the block communication module 110 of FIG. 1) based on a connectedness of the first user in the first region of communication 1 204 and the second number of points and the second region of communication 2 206.

FIG. 2C is a user interface view 250C displaying a webpage associated with a member 106 in a vicinity of the region of communication 1 204, according to one embodiment. Particularly, FIG. 2C illustrates the geo-spatial map 200, the profile block 212, 214 and 216, a welcome message 220, a message block 222 and a region of communication 224, according to one embodiment.

The welcome message 220 may display a name of the member 106 (e.g., the owner of the webpage). The message block 222 may display a message related to the member's request to increase the region of communication 224. The region of communication 224 may display a region in which the member 106 (e.g., Randy Jones) has an influence. For example, Randy Jones may create groups, wiki profiles, leave comments and/or testimonials, etc. associated with profiles of other members 106A-N in the region of communication 224.

In the example embodiment illustrated in FIG. 2C, the user interface view 250C displays a webpage of the member 106 (e.g., Randy Jones). The user interface view 250C also displays the profile data (e.g., name, address data, number of points and the region of communication) associated with Randy Jones and other members 106A-N (e.g., John Q. Public and Jane Smith) in vicinity of the region of communication 224. The message block 222 displays “Your region of communication has been increased by 1 mile” which indicates that the radius of the region of communication 224 associated with Randy Jones has been increased from 0.04 miles to 1.04 miles (e.g., based on the number of points (e.g., 1875) and Randy Jones's request).

For example, Randy Jones may submit a request to increase the region of communication 224. As Randy Jones has a higher number of points (1875 points) compared to John Q. Public (1043 points) and Jane Smith (840 points), the region of communication 224 may be increased by 1 mile. In addition, the regions of communication 1 204 and 2 206 are bounded by the region of communication 224 based on the inequality between the number of points and the location associated with Randy Jones.

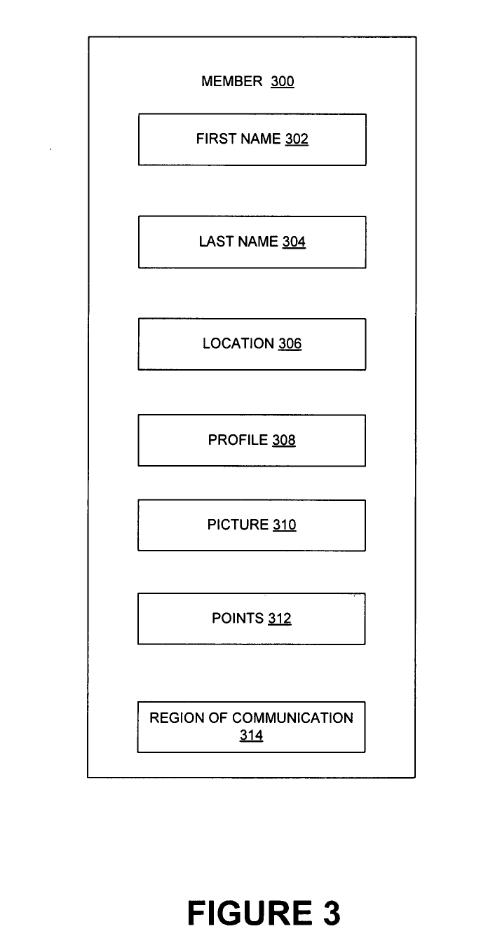

FIG. 3 is a block diagram representation displaying information associated with a member 300, according to one embodiment. In one example embodiment, the information is associated with the member 300 in a community network 102, such as the community network 102 of FIG. 1. Particularly, FIG. 3 illustrates the member 300, a first name block 302, a last name block 304, a location block 306, a profile block 308, a picture block 310, a points block 312 and a region of communication block 314, according to one embodiment.

The member 300 may be an individual having a region of communication 224 in the community network 102. The first name block 302 may display a first name associated with the member 300. The last name block 304 may display a last name associated with the member 300. The location block 306 may display an address data associated with the member 300. The profile block 308 may display profile details associated with the member 300. For example, the profile details may include age, gender, profession, hobbies, etc.

The picture block 310 may display pictures uploaded (e.g., to the webpage) by the member 300. The points block 312 may display a number of points associated with the member 300 (e.g., determined based on an activity level of the member 300). The region of communication block 314 may display the region of communication 224 for the member 300 on a geo-spatial map (e.g., the geo-spatial map 200 of FIGS. 2A, 2B and 2C). For example, the region of communication 224 may be a sphere having a certain radius surrounding the location of the member 300.

In the example embodiment illustrated in FIG. 3, the block diagram representation shows various details (e.g., address data, content data, radius of region of communication, and/or number of points etc.) associated with the member 300. Other members 106A-N may search for the member 300 based on the first name, the last name, the location, the profile, the picture information, the points, and/or the radius of the region of communication 224 associated with the member 300.

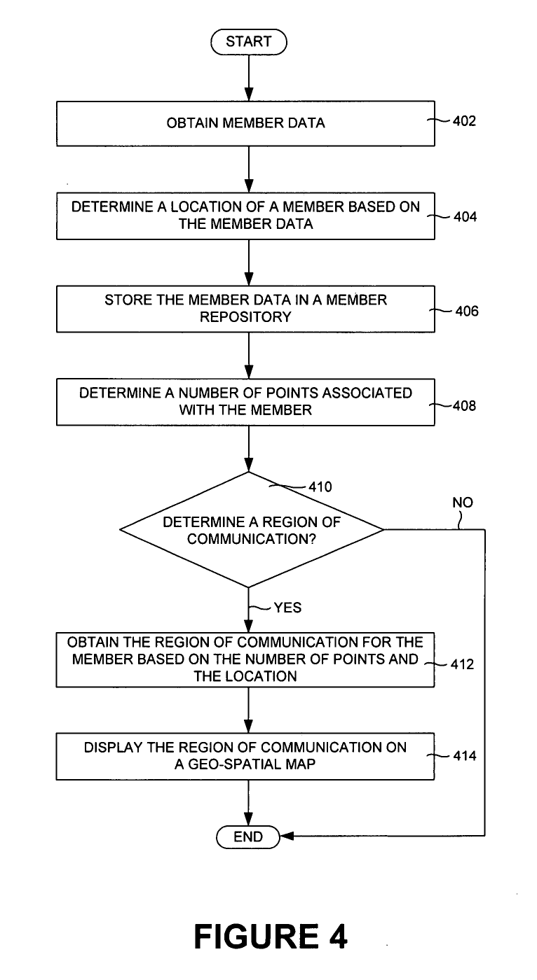

FIG. 4 is a flow chart to obtain a region of communication (e.g., the region of communication 1 204 of FIGS. 2A and 2B) for a member 106, according to one embodiment. In operation 402, a member data associated with the member 106 is obtained (e.g., using the member management module 108 of FIG. 1). For example, the member data may include age, gender, profession, address data, etc. In operation 404, a location of the member 106 is determined (e.g., using the block communication module 110 of FIG. 1) based on the member data. For example, the location may be identified on a geo-spatial map 200 using the member data (e.g., may include address data).

In operation 406, the member data is stored in a member repository (e.g., the member repository 114 of FIG. 1). For example, the location of the member 106 may be determined based on the member data stored in the member repository 114. In addition, the members 106A-N may communicate with each other using the member data stored in the member repository 114. In operation 408, a number of points associated with the member 106 are determined based on an activity level of the member 106. For example, the activity level may refer to participation (e.g., creating profiles, deleting profiles, deleting bad profiles and/or comments, etc.) of the member 106 in the community network 102.

In operation 410, a condition of whether to determine a region of communication 1 204 for the member 106 or not is processed. If the determination is made, then in operation 412, the region of communication 1 204 for the member 106 is obtained (e.g., using the block communication module 110 of FIG. 1) based on the number of points and/or the location associated with the member 106. For example, the region of communication 1 204 may be a sphere drawn on the geo-spatial map 200 corresponding to the number of points. The region of communication 1 204 may increase with the increase in number of points (e.g., determined based on the activity level of the member 106). If the region of communication 1 204 already exists for the member 106, the process may terminate without obtaining the region of communication 224. In operation 414, the region of communication 1 204 is displayed on the geo-spatial map 200.

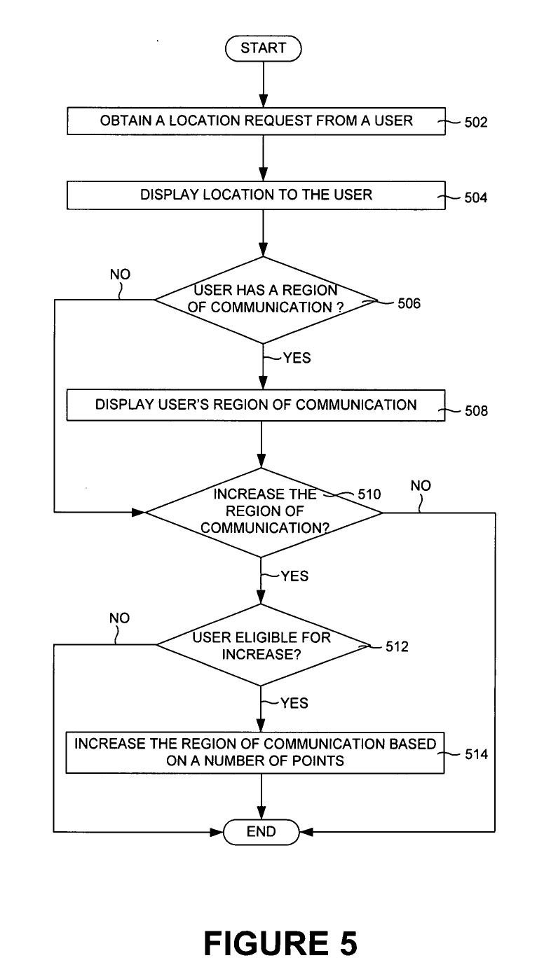

FIG. 5 is a flow chart to increase a region of communication 1 204 of a user (e.g., the member 106 of FIG. 1) based on an eligibility and a number of points, according to one embodiment. In operation 502, a location request is obtained from the user. For example, the user may search for a location on a geo-spatial map 200 (e.g., by entering address data associated with the location (e.g., as a search query)). In operation 504, the location is displayed to the user on the geo-spatial map 200.

In operation 506, it is determined whether the user has a region of communication or not. For example, the region of communication 1 204 may be a sphere drawn with a certain radius (e.g., using the selection tools). If the user has the region of communication 1 204 then the region of communication 1 204 associated with the user is displayed on the geo-spatial map 200, in operation 508.

In operation 510, it is determined whether to increase the user's region of communication 1 204 or not, based on the user's request. For example, the user may request to increase the region of communication 1 204 using the increase your region of communication option 210 of FIG. 2A. If the user has not requested the increase, then the process may terminate. In operation 512, an eligibility of the user for the increase of the user's region of communication 1 204 is determined (e.g., based on the number of points and the location associated with the user). If the user is eligible for the increase of the region of communication 1 204, then the region of communication 1 204 is increased (e.g., as illustrated in FIG. 2B) based on the number of points associated with the user, in operation 514. For example, the number of points may be determined based on an activity level of the user. The activity level may also be estimated based on a list of the activities that the user performs from day to day. In addition, each activity is connected to the user. For example, the activities may include participation of the user in the community network 102. If the user is not eligible (e.g., does not have a higher number of points) for the increase of the region of communication 1 204, then the process may terminate without increasing the region of communication 1 204.

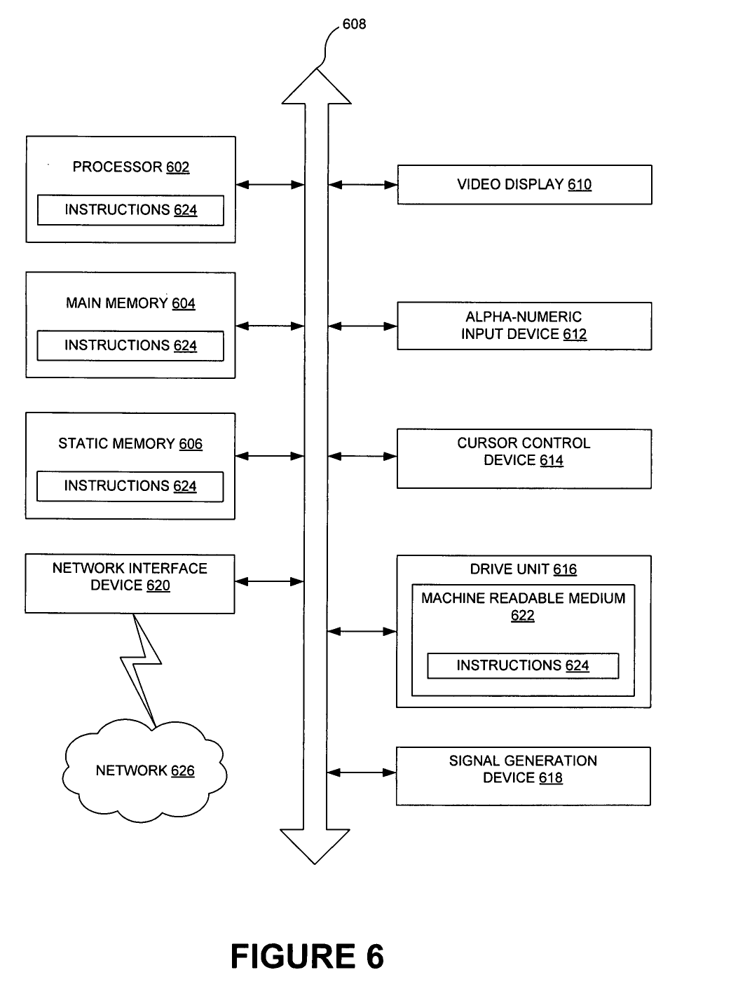

FIG. 6 is a diagrammatic system view 600 of a data processing system in which any of the embodiments disclosed herein may be performed, according to one embodiment. Particularly, the diagrammatic system view 600 of FIG. 6 illustrates a processor 602, a main memory 604, a static memory 606, a bus 608, a video display 610, an alpha-numeric input device 612, a cursor control device 614, a drive unit 616, a signal generation device 618, a network interface device 620, a machine readable medium 622, instructions 624 and a network 626, according to one embodiment.

The diagrammatic system view 600 may indicate a personal computer and/or a data processing system in which one or more operations disclosed herein are performed. The processor 602 may be microprocessor, a state machine, an application specific integrated circuit, a field programmable gate array, etc. (e.g., Intel® Pentium® processor). The main memory 604 may be a dynamic random access memory and/or a primary memory of a computer system.

The static memory 606 may be a hard drive, a flash drive, and/or other memory information associated with the data processing system. The bus 608 may be an interconnection between various circuits and/or structures of the data processing system. The video display 610 may provide graphical representation of information on the data processing system. The alpha-numeric input device 612 may be a keypad, keyboard and/or any other input device of text (e.g., special device to aid the physically handicapped). The cursor control device 614 may be a pointing device such as a mouse.

The drive unit 616 may be the hard drive, a storage system, and/or other longer term storage subsystem. The signal generation device 618 may be a bios and/or a functional operating system of the data processing system. The network interface device 620 may be a device that may perform interface functions such as code conversion, protocol conversion and/or buffering required for communication to and from a network. The machine readable medium 622 may provide instructions on which any of the methods disclosed herein may be performed. The instructions 624 may provide source code and/or data code to the processor 602 to enable any one or more operations disclosed herein.

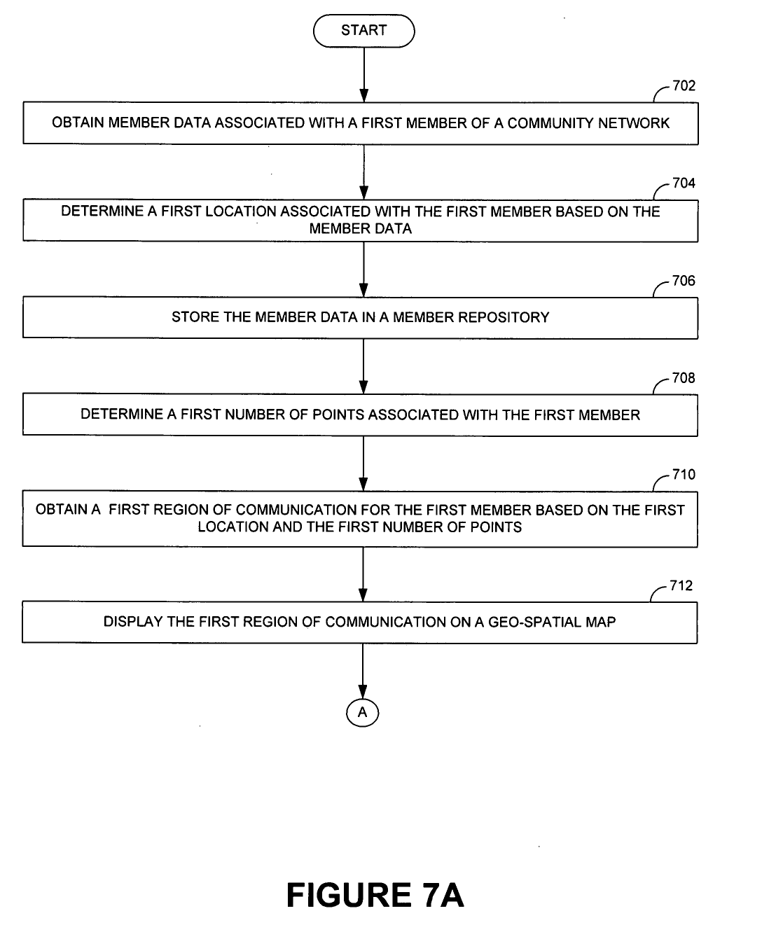

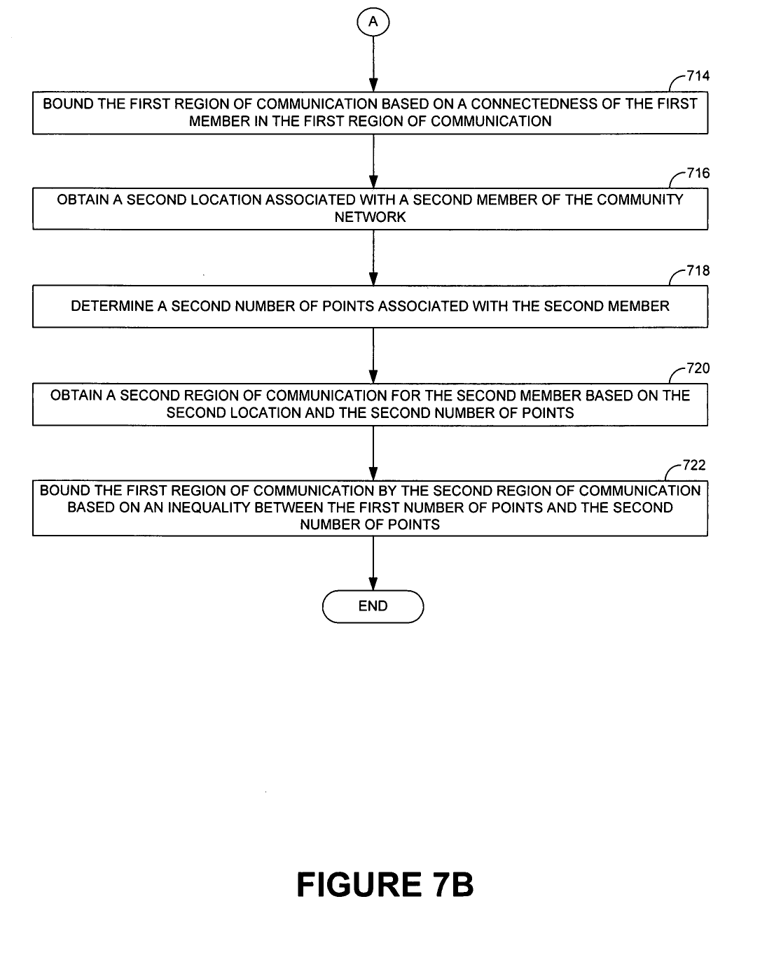

FIG. 7A is a process flow illustrating a method of communication in a neighborhood block, according to one embodiment. In operation 702, member data associated with a first member 106 of the community network 102 may be obtained (e.g., using the member management module 108 of FIG. 1). In operation 704, a first location (e.g., may include a latitude and longitude coordinate) associated with the first member 106 may be determined (e.g., using the geo-spatial repository 112 of FIG. 1) based on the member data. In operation 706, the member data may be stored in a member repository (e.g., the member repository 114 of FIG. 1).

In operation 708, a first number of points associated with the first member 106 may be determined (e.g., based on an activity level of the first member 106). In operation 710, a first region of communication 1 204 (e.g., may include a sphere) may be obtained (e.g., using the block communication module 110 of FIG. 1) for the first member 106 based on the first location and the first number of points. In operation 712, the first region of communication 1 204 may be displayed on a geo-spatial map (e.g., the geo-spatial map 200 of FIG. 2A).

FIG. 7B is a continuation of the process flow of FIG. 7A, showing additional processes, according to one embodiment. In operation 714, the first region of communication 1 204 may be bounded (e.g., using the block communication module 110 of FIG. 1) based on a connectedness of the first member 106 in the first region of communication 1 204. In operation 716, a second location associated with a second member 106 of the community network 102 may be obtained (e.g., using the member repository 114 of FIG. 1). In operation 718, a second number of points associated with the second member 106 may be determined (e.g., based on an activity level of the second member 106).

In operation 720, a second region of communication 3 208 may be obtained (e.g., using the block communication module 110 of FIG. 1) for the second member 106 based on the second location and the second number of points. In operation 722, the first region of communication 1 204 may be bounded (e.g., using the block communication module 110 of FIG. 1) by the second region of communication 2 206 based on an inequality between the first number of points and the second number of points.

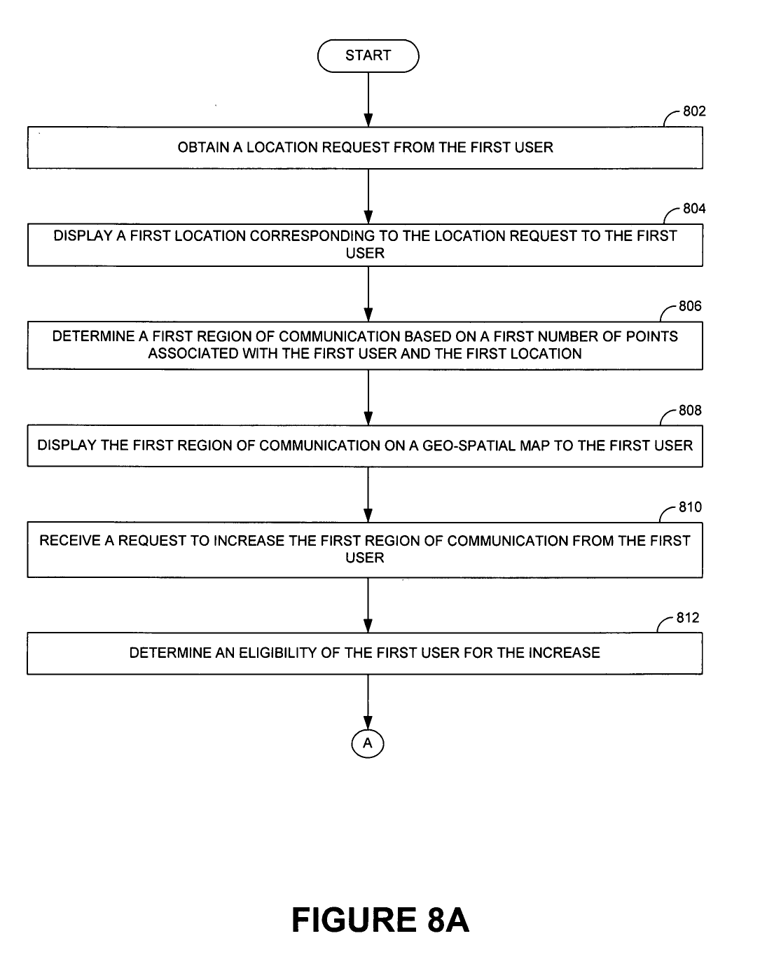

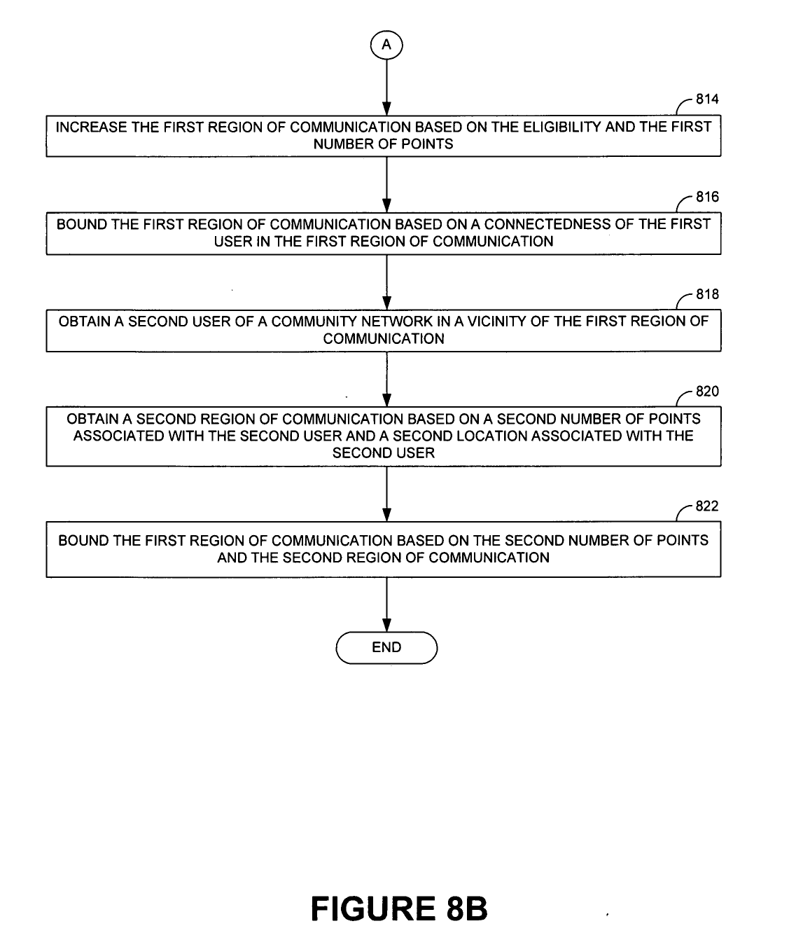

FIG. 8A is a process flow of bounding a first region of communication (e.g., the region of communication 1 204 of FIG. 2B) based on a second number of points and a second region of communication (e.g., the region of communication 2 206 of FIG. 2B), according to one embodiment. In operation 802, a location request may be obtained from the first user. In operation 804, a first location corresponding to the location request may be displayed (e.g., through the geo-spatial map 200 of FIG. 2B) to the first user.

In operation 806, the first region of communication 1 204 (e.g., may include a sphere) may be determined (e.g., using the block communication module 110 of FIG. 1) based on a first number of points (e.g., determined based on an activity level of the first user) associated with the first user and the first location. In operation 808, the first region of communication 1 204 may be displayed on a geo-spatial map 200 to the first user. In operation 810, a request to increase the first region of communication 1 204 may be received (e.g., when the first member clicks on the increase your region of communication option 210 of FIG. 2A) from the first user. In operation 812, an eligibility of the first user for the increase may be determined (e.g., using the block communication module 110 of FIG. 1).

FIG. 8B is a continuation of the process flow of FIG. 8A, showing additional processes, according to one embodiment. In operation 814, the first region of communication 1 204 may be increased based on the eligibility and the first number of points. In operation 816, the first region of communication 1 204 may be bounded (e.g., using the block communication module 110 of FIG. 1) based on a connectedness of the first user in the first region of communication 1 204. In operation 818, a second user of the community network 102 in a vicinity of the first region of communication 1 204 may be obtained.

In operation 820, a second region of communication 2 206 (e.g., may include a sphere) may be obtained (e.g., using the block communication module 110 of FIG. 1) based on the second number of points (e.g., determined based on an activity level of the second user) associated with the second user and a second location associated with the second user. In operation 822, the first region of communication 1 204 may be bounded (e.g., using the block communication module 110 of FIG. 1) based on the second number of points and the second region of communication 2 206.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various electrical structure and methods may be embodied using transistors, logic gates, and electrical circuits (e.g., Application Specific Integrated Circuitry (ASIC) and/or in Digital Signal Processor (DSP) circuitry). For example, the member management module 108, the block communication module 110 and other modules of FIGS. 1-8B may be may be enabled using a member management circuit, a block communication circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of communication in a neighborhood block, comprising:
obtaining member data associated with a first member of the community network;
determining a first location associated with the first member based on the member data;
storing the member data in a member repository;
determining a first number of points associated with the first member; and
obtaining a first region of communication for the first member based on the first location and the first number of points.

2. The method of claim 1, further comprising:
displaying the first region of communication on a geo-spatial map.

3. The method of claim 1, further comprising:
bounding the first region of communication based on a connectedness of the first member in the first region of communication.

4. The method of claim 1, further comprising:
obtaining a second location associated with a second member of the community network;
determining a second number of points associated with the second member;
obtaining a second region of communication for the second member based on the second location and the second number of points; and
bounding the first region of communication by the second region of communication based on an inequality between the first number of points and the second number of points.

5. The method of claim 1, wherein the first number of points is based on an activity level of the first member.

6. The method of claim 1, wherein the first region of communication comprises a sphere.

7. The method of claim 1 in a form of a machine-readable medium embodying a set of instructions that, when executed by a machine, causes the machine to perform the method of claim 1.

8. A community network, comprising:
a member repository comprising a plurality of members;
a geo-spatial repository comprising a plurality of locations on a geo-spatial map;
a member management module configured to obtain member data associated with each of the plurality of members; and
a block communication module configured to:
determine a first of the plurality of locations associated with a first of the plurality of members based on the member data;
store the member data in the member repository;
determine a first number of points associated with the first of the plurality of members; and
obtain a first region of communication for the first of the plurality of members based on the first of the plurality of locations and the first number of points.

9. The community network of claim 8, wherein the member management module is further configured to:
determine an activity level of each of the plurality of members in the member repository,
wherein the first number of points is based on the activity level of the first of the plurality of members.

10. The community network of claim 8, wherein the block communication module is further configured to:
display the first region of communication on the geo-spatial map.

11. The community network of claim 8, wherein the block communication module is further configured to:
bound the first region of communication based on a connectedness of the first member in the first region of communication.

12. The community network of claim 8, wherein the block communication module is further configured to:
obtain a second of the plurality of locations associated with a second of the plurality of members;
determine a second number of points associated with the second of the plurality of members;
obtain a second region of communication for the second of the plurality of members based on the second of the plurality of locations and the second number of points; and
bound the first region of communication by the second region of communication based on an inequality between the first number of points and the second number of points.

13. The community network of claim 8, wherein the first region of communication comprises a sphere.

14. The community network of claim 8, wherein each of the plurality of locations comprises a latitude and a longitude.

15. A method of configuring a community network for a first user, comprising:
obtaining a location request from the first user;
displaying a first location corresponding to the location request to the first user;
determining a first region of communication based on a first number of points associated with the first user and the first location; and
displaying the first region of communication on a geo-spatial map to the first user.

16. The method of claim 15, further comprising:
receiving a request to increase the first region of communication from the first user;
determining an eligibility of the first user for the increase; and
increasing the first region of communication based on the eligibility and the first number of points.

17. The method of claim 15, further comprising:
bounding the first region of communication based on a connectedness of the first user in the first region of communication.

18. The method of claim 15, further comprising:
obtaining a second user of the community network in a vicinity of the first region of communication;
obtaining a second region of communication based on a second number of points associated with the second user and a second location associated with the second user; and
bounding the first region of communication based on the second number of points and the second region of communication.

19. The method of claim 15, wherein the first number of points is based on an activity level of the first user.

20. The method of claim 15, wherein the first region of communication comprises a sphere.
